(19) United States
(12) Patent Application Publication
(10) Pub. No.: US 2026/0196541 A1
(43) Pub. Date: Jul. 9, 2026

(54) Methods and Systems For Detecting A Leak In A Fuel-Cell System

(71) Applicant: Schaeffler Technologies AG & Co. KG, Herzogenaurach (DE)

(72) Inventor: Hong Zhang, Tegernheim (DE)

(73) Assignee: Schaeffler Technologies AG & Co. KG, Herzogenaurach (DE)

(21) Appl. No.: 19/131,359

(22) PCT Filed: Nov. 16, 2023
(86) PCT No.: PCT/EP2023/081990

§ 371 Date: May 20, 2025

(30) Foreign Application Priority Data
Nov. 22, 2022 (DE) 10 2022 212 448.0

(51) Int. Cl. H01M 8/04664; H01M 8/0444; H01M 8/04746

(52) U.S. Cl. CPC H01M 8/04671; H01M 8/04462; H01M 8/04753; H01M 8/04761

(57) ABSTRACT

An example includes: receiving a hydrogen signal representing a hydrogen concentration in a gas mixture present in the exhaust system; transmitting a diagnosis signal prompting the fuel-cell system to change into a diagnostic operating mode, if the received hydrogen signal indicates a hydrogen concentration value in the exhaust system exceeding a predetermined hydrogen concentration threshold value; determining a membrane of a fuel cell of the fuel-cell system is at least partially leaky if the hydrogen signal received during the diagnostic operation of the fuel-cell system is essentially decreasing, or a flushing valve arranged in the anode line system is at least partially leaky if the hydrogen signal received during the diagnostic operation of the fuel-cell system is not essentially decreasing; and transmitting a control signal indicating which of the membrane or the flushing valve is at least partially leaky.

### CROSS-REFERENCE TO RELATED APPLICATIONS

This application is a U.S. National Stage Application of International Application No. PCT/EP2023/081990 filed Nov. 16, 2023, which designates the United States of America, and claims priority to DE Application No. 10 2022 212 448.0 filed Nov. 22, 2022, the contents of which are hereby incorporated by reference in their entirety.

### TECHNICAL FIELD

The present disclosure relates to fuel cell systems. Various embodiments of the teachings herein include methods, control devices, and/or computer programs for determining a leak in a fuel-cell system.

### BACKGROUND

Fuel-cell systems are typically refueled using a gas mixture consisting essentially of hydrogen. For this purpose, it is desirable for the refueled gas mixture to have a hydrogen concentration which is greater than 99%. This high hydrogen concentration in the gas mixture can prevent early aging and efficiency losses of the fuel cell.

Hydrogen sensors based on the thermal conductivity measuring principle are known from the prior art. The thermal conductivity of the entire gas mixture is determined, from which the concentration of the hydrogen in the gas mixture can be derived, since the thermal conductivity of hydrogen is significantly greater than the thermal conductivity of many other gas components in the gas mixture.

For example, U.S. Pat. No. 8,795,917 B2, CN 114 838 937 A, JP 2010/067573 A, U.S. Pat. Nos. 10,581,100 B2, and 11,201,340 B2 are known from the prior art.

### SUMMARY

The teachings of the present disclosure include systems and methods for locating the point of the leak when a leak is detected in a fuel-cell system. For example, some embodiments of the teachings herein include a method for detecting a leak in a fuel-cell system (100), which comprises an exhaust system (150), wherein the method comprises: receiving a hydrogen signal from a hydrogen sensor (151) arranged in the exhaust system (150), wherein the hydrogen signal is representative of a hydrogen concentration in a gas mixture present in the exhaust system (150), transmitting a diagnosis signal, which prompts the fuel-cell system (100) to change into a diagnostic operating mode, if the received hydrogen signal indicates a hydrogen concentration value in the exhaust system (150) which exceeds a predetermined hydrogen concentration threshold value, detecting that a membrane of the fuel cell (110) of the fuel-cell system (100) is at least partially leaky if the hydrogen signal received during the diagnostic operation of the fuel-cell system (100) is essentially decreasing, or that a flushing valve (137) arranged in the anode line system (130) is at least partially leaky if the hydrogen signal received during the diagnostic operation of the fuel-cell system (100) is essentially not decreasing, and transmitting a control signal which indicates that the membrane or the flushing valve (137) is at least partially leaky.

In some embodiments, transmitting the diagnosis signal comprises: transmitting a cathode inlet valve closing signal, which causes closing of a cathode inlet valve (145) arranged in a cathode feed line (142) of a cathode line system (140), wherein the cathode feed line (142) is designed to supply a gas mixture comprising oxygen to a cathode of the fuel-cell system, and/or transmitting a cathode outlet valve closing signal, which causes closing of a cathode outlet valve (147) arranged in a cathode discharge line (146) of the cathode line system (140), wherein the cathode discharge line (146) is designed to discharge the gas mixture comprising oxygen, supplied to the cathode of the fuel-cell system (100), into the exhaust system (150).

In some embodiments, transmitting the diagnosis signal furthermore comprises: transmitting a bypass valve opening signal, which causes at least partial opening of a cathode bypass valve (149) arranged in a cathode bypass line (148) connecting the cathode feed line (145) to the cathode discharge line (146), wherein detecting that the membrane of the fuel cell (110) of the fuel-cell system (100) is at least partially leaky comprises detecting that the hydrogen signal received during the diagnostic operation of the fuel-cell system (100) indicates a hydrogen concentration value of essentially zero, and/or wherein detecting that the flushing valve (137) of the fuel-cell system (100) is at least partially leaky comprises detecting that the hydrogen signal received during the diagnostic operation of the fuel-cell system (100) indicates a hydrogen concentration value which is greater than zero.

In some embodiments, transmitting the diagnosis signal comprises transmitting a throttle valve closing signal, which causes closing of a throttle valve (145) arranged in the cathode discharge line (142) downstream from the cathode outlet valve (147).

In some embodiments, the control signal is designed to actuate an operator interface to display a warning to an operator of the fuel-cell system (100), wherein the warning informs the operator that a leak of the membrane or the flushing valve (137) has been detected.

As another example, some embodiments include a control device (160), which is designed to execute one or more of the methods as described herein.

In some embodiments, the control device (160) comprises: a first control device section (162) for executing the step of receiving a hydrogen signal from the hydrogen sensor (151), a second control device section (164) for executing the step of transmitting a diagnosis signal, a third control device section (166) for executing the step of detecting that the membrane or the flushing valve (137) is at least partially leaky, and a fourth control device section (168) for executing the step of transmitting a control signal.

As another example, some embodiments include a leaktightness-analyzing device (180) for a fuel-cell system (100), comprising: a hydrogen sensor (151), which is designed to generate a hydrogen signal that is representative of a hydrogen concentration in a gas mixture present in an exhaust system (150) of the fuel-cell system (100), and a control device (160) as described herein.

As another example, some embodiments include a fuel-cell system (100), comprising: an anode, a cathode separated from the anode by means of a membrane, an anode line system (130), in which a flushing valve (137) is arranged, an exhaust system (150), which is fluidically connected to the anode line system (130), and a leaktightness-analyzing device (180) as claimed in claim 8.

As another example, some embodiments include a computer program comprising commands which, when they are executed by a computing unit, prompt the computing unit to carry out one or more of the methods as described herein.

As another example, some embodiments include a computer-readable medium on which one or more of the computer programs as described herein is stored.

As another example, some embodiments include use of a hydrogen sensor (151) arranged in an exhaust system (150) of a fuel-cell system (100) to detect a leak in the fuel-cell system (100) by means of one or more of the methods as described herein.

### BRIEF DESCRIPTION OF THE DRAWINGS

Further advantages and features of the teachings of the present disclosure will become apparent to a person skilled in the art by putting the teaching described herein into practice and taking into consideration the accompanying single drawing, in which:

FIG. 1 shows a schematic representation of a fuel-cell system for a vehicle incorporating teachings of the present disclosure;

FIG. 2 shows a diagram in which exemplary courses of hydrogen signals of the hydrogen sensor arranged in the exhaust system of the fuel-cell system of FIG. 1 are plotted in the case of a leaky membrane or leaky flushing valve; and

FIG. 3 shows a flow chart of an example method incorporating teachings of the present disclosure for determining a leak in a fuel-cell system.

### DETAILED DESCRIPTION

Upon detecting a leak in a fuel-cell system, the methods and systems described herein may be used to locate the leak by evaluation of the signals of a hydrogen sensor arranged in an exhaust line of the fuel-cell system, in particular whether the leak is established in the membrane of the fuel cell or in a flushing valve arranged in an anode line system of the fuel-cell system. For this purpose, initially any leak is detected in the fuel-cell system by means of the hydrogen sensor arranged in the exhaust system and thereupon the fuel-cell system is switched into a diagnostic operating mode, during which no gas mixture which previously interacted with the cathode can be present in the exhaust system of the fuel-cell system. By evaluating the course of the hydrogen sensor signal, which is received during the diagnostic operating mode of the hydrogen sensor arranged in the exhaust system of the fuel-cell system, locating of the leak can be carried out. If the course of the hydrogen signal is essentially decreasing during the diagnostic operating mode, a leaky membrane of the fuel cell of the fuel-cell system can be detected. However, if the course of the hydrogen signal is essentially not decreasing, in particular is essentially constant or even increasing, during the diagnostic operating mode, the leaky point can be assigned to the flushing valve.

Some embodiments of the teachings herein include a method including receiving a hydrogen signal from a hydrogen sensor arranged in the exhaust system. The hydrogen signal is representative of a hydrogen concentration in a gas mixture present in the exhaust system. The method furthermore comprises transmitting a diagnosis signal, which prompts the fuel-cell system to change into a diagnostic operating mode, if the received hydrogen signal indicates a hydrogen concentration value in the exhaust system which exceeds a predetermined hydrogen concentration threshold value, detecting that a membrane of the fuel cell of the fuel-cell system is at least partially leaky, because the hydrogen signal received during the diagnostic operation of the fuel-cell system is essentially decreasing, or that a flushing valve arranged in the anode line system is at least partially leaky if the hydrogen signal received during the diagnostic operation of the fuel-cell system is essentially not decreasing, and transmitting a control signal which indicates that the membrane or the flushing valve is at least partially leaky. Therefore, the leaky point in the fuel-cell system can be located by evaluating the hydrogen signal of the hydrogen sensor arranged in the exhaust system of the fuel-cell system, in particular after a leak in the fuel-cell system has been detected in general and the fuel-cell system has been switched into the diagnostic operating mode.

In some embodiments, transmitting the diagnosis signal comprises transmitting a cathode inlet valve closing signal, which causes closing of a cathode inlet valve arranged in a cathode feed line of a cathode line system, and/or transmitting a cathode outlet valve closing signal, which causes closing of a cathode outlet valve arranged in a cathode discharge line of the cathode line system. The cathode feed line is designed here to supply a gas mixture comprising oxygen to a cathode of the fuel-cell system. The cathode discharge line is designed to discharge the gas mixture comprising oxygen, supplied to the cathode of the fuel-cell system, into the exhaust system.

According to this embodiment, it is possible to preclude, during the diagnostic operating mode of the fuel-cell system, a gas mixture which has previously interacted with the cathode of the fuel cell of the fuel-cell system from being present in the exhaust system of the fuel-cell system, so that the locating of the leak according to the invention can take place. The elevated hydrogen concentration in the exhaust system can originate here either from the anode line system, in particular with a leaky flushing valve, or from the cathode line system, in particular with a leaky membrane of the fuel cell of the fuel-cell system. The leak can be located in a simple manner by the closing of the cathode line, which is connected to the cathode of the fuel cell of the fuel-cell system.

In some embodiments, transmitting the diagnosis signal furthermore comprises transmitting a bypass valve opening signal, which causes at least partial opening of a cathode bypass valve arranged in a cathode bypass line connecting the cathode feed line to the cathode discharge line. Detecting that the membrane of the fuel cell of the fuel-cell system is at least partially leaky can in this case comprise detecting that the hydrogen signal received during the diagnostic operation of the fuel-cell system indicates a hydrogen concentration value of essentially zero. In some embodiments, detecting that the flushing valve of the fuel-cell system is at least partially leaky can comprise detecting that the hydrogen signal received during the diagnostic operation of the fuel-cell system indicates a hydrogen concentration value which is greater than zero.

The diagnosis and locating of the leak can be accelerated by transmitting the bypass valve opening signal, since the exhaust system is flushed out using the gas mixture originating from the cathode line system and comprising oxygen, which has not flowed past the cathode of the fuel cell, such that as a result any hydrogen present in the exhaust system can exclusively originate from the anode system due to a potentially leaky flushing valve. In some embodiments, transmitting the diagnosis signal comprises transmitting a throttle valve closing signal, which causes closing of a throttle valve arranged in the cathode discharge line downstream from the cathode outlet valve. Complete disconnection of the cathode line system from the exhaust system can be induced by means of the closing of the throttle valve. If hydrogen is thereupon still detected in the exhaust system by means of the hydrogen sensor, it would have to originate from the anode line system due to a leaky flushing valve.

In some embodiments, the control signal is furthermore designed to actuate an operator interface to display a warning to an operator of the fuel-cell system. The warning informs the operator that a leak of the membrane or the flushing valve has been detected.

Some embodiments include a control device designed to execute one or more of the methods described herein. In some embodiments, the control device comprises a first control device section for executing the step of receiving a hydrogen signal from the hydrogen sensor, a second control device section for executing the step of transmitting a diagnosis signal, a third control device section for executing the step of detecting that the membrane or the flushing valve is at least partially leaky, and a fourth control device section for executing the step of transmitting a control signal.

In some embodiments, a leaktightness-analyzing device for a fuel-cell system comprises a hydrogen sensor, which is designed to generate a hydrogen signal that is representative of a hydrogen concentration in a gas mixture present in an exhaust system of the fuel-cell system, and a control device according to the invention.

In some embodiments, a fuel-cell system comprises an anode, a cathode separated from the anode by means of a membrane, an anode line system, in which a flushing valve is arranged, an exhaust system, which is fluidically connected to the anode line system, and a leaktightness-analyzing device incorporating teaching of the present disclosure.

In some embodiments, a computer program comprises commands which, when they are executed by a computing unit, prompt the computing unit to carry out one or more of the methods for detecting a leak in a fuel-cell system described herein. In some embodiments, a computer-readable medium stores a computer program incorporating teachings of the present disclosure.

Some embodiments include the use of a hydrogen sensor arranged in an exhaust system of a fuel-cell system for detecting a leak in the fuel-cell system according to one or more of the methods described herein.

In the scope of the present disclosure, the term “gas mixture” describes a mixture made up of various gaseous components, such as hydrogen, nitrogen, air, and/or an inert gas, for example, argon.

In the scope of the present disclosure, the term “signal” describes raw data which are converted for data transfer into a form which can be sent via the selected transport medium. This can take place in an analog or digital manner, wherein the data are first sampled and converted into discrete (often binary coded) values, which are then sent as pulses or voltages of different levels via the medium.

Furthermore, the signals can be transmitted or received continuously in the scope of the present disclosure. For example, the transmitting and receiving of digital signals take place at an interval of a few milliseconds.

In the scope of the present disclosure, the term “diagnostic operating mode of the fuel-cell system” describes an operating mode of the fuel-cell system in which the various components and elements of the fuel-cell system are actuated and operated differently than in the normal operating mode, which comprises possible flushing procedures of the anode line system, for diagnosing the cathode outlet valve.

In the scope of the present disclosure, a “sufficiently leak-tight point” describes that the respective element, in a closed or intact state, blocks a respective connecting path such that the gas mixture flowing through the line essentially cannot flow through the element. However, it is also within the scope of the present disclosure that an element having a leak of approximately 0.1 standard millimeters per minute [Sml/min] at an overpressure of approximately 600 mbar can also be designated as “sufficiently leak-tight”. Therefore, an element can be designated as “leaky” in the context of the present disclosure if the leak through it is above the mentioned 0.1 Sml/min at an overpressure of approximately 600 mbar.

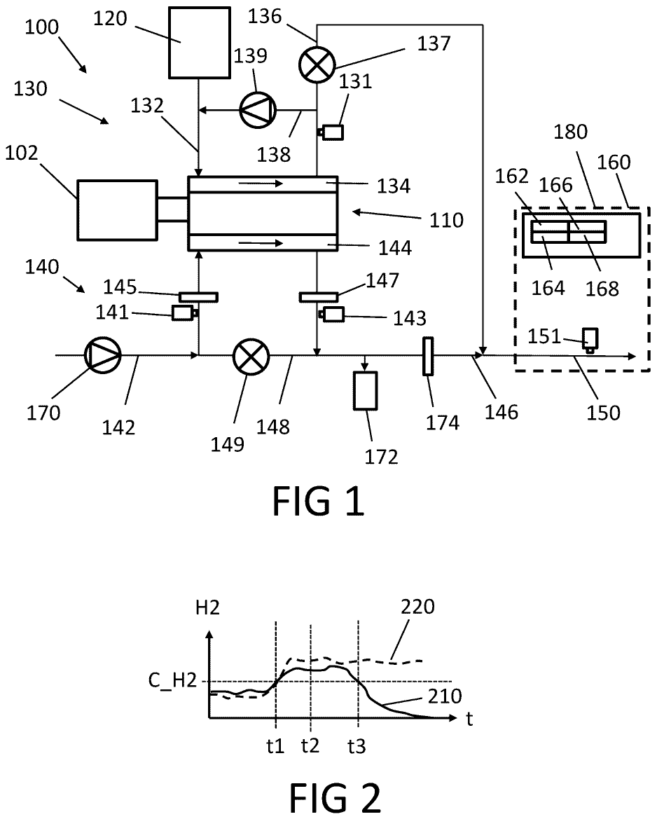

FIG. 1 shows a schematic representation of a fuel-cell system 100 incorporating teachings of the present disclosure for a vehicle. The fuel-cell system 100 comprises a fuel cell 110, for example a fuel cell stack. The fuel cell 110 comprises in this case, as is known from the prior art, an anode and a cathode, which are separated from one another by a membrane. For example, the fuel cell 110 can be a so-called PEM fuel cell, in which the membrane is a proton exchange membrane through which the protons formed on the anode can reach the cathode.

The fuel-cell system 100 furthermore comprises a tank 120, in which a gas mixture which essentially consists of hydrogen is stored, preferably under pressure. The tank 120 can moreover comprise valves (not explicitly shown in FIG. 1), with which the inflow and outflow of the gas mixture into the tank 120 and out of the tank 120 can be controlled.

The fuel-cell system 100 of FIG. 1 furthermore comprises an anode line system 130, which is designed to supply the gas mixture flowing out of the tank 120 to the anode of the fuel cell 110 and to discharge or return the gas mixture flowing past the anode. The anode line system 130 comprises for this purpose an anode feed line 132, which is fluidically connected to the tank 120 and which supplies the gas mixture flowing out of the tank 120 to an anode line 134, which in turn supplies the gas mixture to the anode of the fuel cell 110. The anode line system 130 furthermore comprises an anode discharge line 136, which is fluidically connected to the anode line 134 and which can discharge the gas mixture flowing through the anode line 134 and supply it to an exhaust system 150. The anode line system 130 furthermore comprises an anode recirculation line 138, which fluidically connects the anode discharge line 136 to the anode feed line 132 and in which a recirculation pump 139 is arranged, which is designed to recirculate the gas mixture flowing through the anode discharge line 136 back to the anode feed line 132. Therefore, a circuit forms between the anode feed line 132, the anode line 134, the anode discharge line 136, and the anode recirculation line 138, in which the gas mixture can be circulated by means of the recirculation pump 139 and guided in the circuit.

The anode line system 130 furthermore comprises a flushing valve 137, which is arranged in the anode discharge line 136 downstream from the orifice point of the anode recirculation line 138 and is designed to release or block the anode discharge line 136. In a normal operating mode of the fuel cell 110, the flushing valve 137 is closed, so that the circuit and recirculation procedure of the gas mixture just described can be provided by means of the recirculation pump 139.

Furthermore, a gas sensor 131, such as a hydrogen sensor, is provided in the anode discharge line 136 and is designed to generate a hydrogen signal that is representative of the hydrogen concentration in the anode discharge line 136 at a position between the anode line 134 and the flushing valve 137. The gas sensor 131 can be a gas sensor based on the thermal conductivity principle here. The hydrogen signals of the hydrogen sensor 131 are preferably digital signals or data which can be processed by a data processing device, which can comprise a processor and a memory.

During the normal operating mode of the fuel-cell system 100, an increasing nitrogen concentration forms within the above-described circuit, because of which the signals of the gas sensor 131 are furthermore representative of a nitrogen concentration within the anode line system. In particular, it can be qualitatively stated that the gas mixture located in the anode line system 130 during the normal operating mode of the fuel-cell system 100 nearly exclusively consists of hydrogen and nitrogen, i.e. that the sum of hydrogen concentration and nitrogen concentration in the anode line system 130 results in a total of 100%. Therefore, both the hydrogen concentration and the nitrogen concentration in the anode line system 130 can be determined on the basis of the signal of the gas sensor 131.

The fuel-cell system 100 furthermore comprises a cathode line system 140 consisting of a cathode feed line 142, a cathode line 144 connected to the cathode, and a cathode discharge line 146. Moreover, the cathode line system 140 comprises a cathode bypass line 148, which fluidically connects the cathode feed line 142 to the cathode discharge line 146 and in which a cathode bypass valve 149 for blocking or releasing the cathode bypass line 148 is arranged. The cathode discharge line 146 can discharge the air supplied to the cathode via the cathode feed line 142 into the exhaust system 150. A pressure sensor 141 for detecting the pressure in the cathode feed line 142 and a cathode inlet valve 145, which can be a butterfly valve, for example, are arranged in the cathode feed line 142. In a similar manner, the cathode discharge line 146 comprises a cathode outlet valve 147 and a pressure sensor 143 arranged downstream thereof in the cathode discharge line 146 for detecting the pressure in the cathode discharge line 146. Moreover, a compressor 170 for compressing the air, a water separator 172, and a throttle valve 174 are arranged in the cathode line system 140.

The throttle valve 174 is arranged in the cathode discharge line 146 at a position downstream from the orifice point of the bypass line 168 into the cathode discharge line 146 and is designed to release or block the cathode discharge line 146. By closing the throttle valve, the cathode line system 140 can be blocked such that the gas mixture flow between compressor 170 and throttle valve 174 is deactivated or comes to a standstill.

The fuel-cell system 100 of FIG. 1 furthermore comprises an onboard network branch 102, which comprises electrical consumers. In particular, the onboard network branch 102 describes at least a part of an electrical system, which can store and distribute the electrical energy generated by the fuel cell 110.

As already described, both the anode line system 130 and the cathode line system 140 open into an exhaust system 150, in which a hydrogen sensor 151 is arranged, which is designed to generate a hydrogen signal that indicates the hydrogen concentration in the gas mixture (in particular exhaust gas) present in the exhaust system 150. The hydrogen sensor 151 can be a gas sensor based on the thermal conductivity principle here.

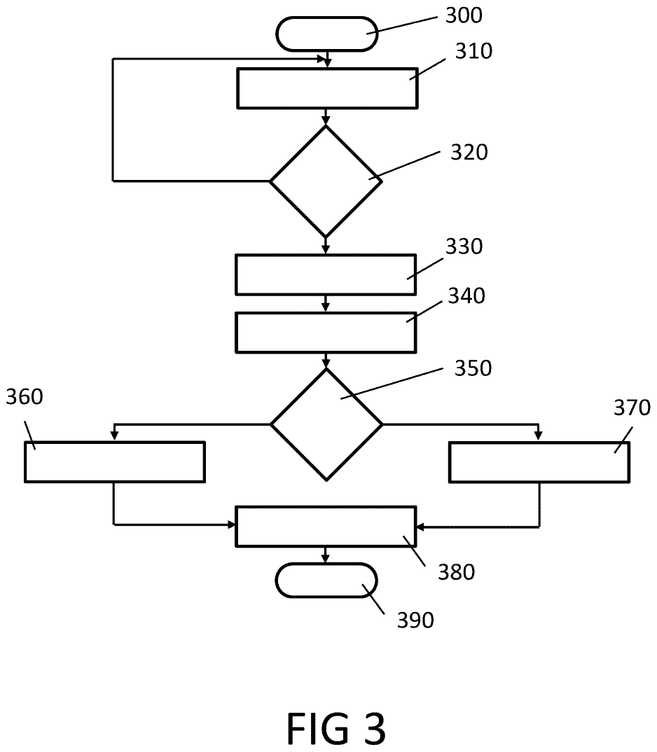

Control device 160 can be connected to all components of the fuel-cell system 100. Although no separate lines are shown for this purpose in FIG. 1, such electrical connecting lines can be present in the form of connecting lines or wires or wireless communication units. The control device 160 can comprise multiple control device sections, such as a first control device section 162, a second control device section 164, a third control device section 166, and a fourth control device section 168, which will be described in more detail hereinafter with reference to FIG. 3.

The control device 160 can comprise a processor or a computing unit and a memory. In some embodiments, the control device 160 can be the processor or the computing unit, which is connected to the memory. The processor can be a central processing unit (CPU). The processor can furthermore be a further all-purpose processor, a digital signal processor (DSP), an application-specific integrated circuit (ASIC), a field-programmable gate array (FPGA), or another programmable logic device, a discrete gate logic device or transistor logic device, a discrete hardware component, or the like. The all-purpose processor can be a microprocessor, or the processor can be an arbitrary conventional processor or the like.

The memory comprises a random access memory (RAM), a read-only memory (ROM), an erasable programmable read-only memory (EPROM), or a portable read-only memory (for example, CD-ROM), but is not restricted thereto. The memory is configured to store associated program instructions and associated data.

The hydrogen sensor 151 forms, together with the control device 160, a leaktightness-analyzing device 180 for the fuel-cell system 100.

FIG. 2 shows a diagram in which exemplary courses 210, 220 of hydrogen signals of the hydrogen sensor 151 arranged in the exhaust system 150 of the fuel-cell system 100 are plotted. In particular, the course 210 describes the hydrogen signal received by the hydrogen sensor 151 in the case in which the membrane of the fuel cell 110 is at least partially leaky, whereas the course 220 shows the hydrogen signal of the hydrogen sensor 151 in the case in which the flushing valve 137 is at least partially leaky.

In FIG. 2, the first time t1 indicates the time at which a leak of the fuel-cell system 100 occurs. The time t2 indicates the time at which the fuel-cell system 100 is switched into a diagnostic operating mode. In particular, the cathode inlet valve 145 and/or the cathode outlet valve 147 are closed for this purpose at the time t2. After the time t2, the evaluation according to the invention of the hydrogen signal of the hydrogen sensor 151 then takes place in order to locate a leak detected in the fuel-cell system 100, for example, at the time t3, which can be approximately 5 seconds after the time t2.

Before the time t1 in FIG. 2, the two courses 210, 220 of the hydrogen signal of the hydrogen sensor 151 each show a hydrogen concentration value falling below a hydrogen concentration threshold value C_H2, such as 8%. Therefore, a leak of the fuel-cell system 10 can already be detected in general on the basis of exceeding the hydrogen concentration threshold value C_H2.

Before the time t1, the fuel-cell system 100 is furthermore in a normal operating mode, in which the flushing valve 137 is closed and the recirculation pump 139 is activated. During the normal operating mode of the fuel-cell system 100, as already described, the gas mixture, in particular the hydrogen mixture, originating from the tank 120, is circulated or permanently circulated in the circuit between the anode feed line 132, anode line 134, anode discharge line 136 and, due to the closed flushing valve 137, the anode recirculation line 138. If, during this normal operating mode, before the time t1, a hydrogen concentration is determined in the exhaust system 150 which is above a predetermined hydrogen concentration threshold value C_H2, such as 8%, the already detected general leak of the fuel-cell system 100 can additionally also be located according to the invention by means of carrying out a flushing procedure and subsequently evaluating the hydrogen signal at the time t3.

Upon starting of a flushing procedure of the anode line system 130 at the time t1, at the same time, the flushing valve 137 is opened and the recirculation pump 139 is deactivated, so that at this time the gas mixture, in particular the hydrogen mixture, flowing out of the tank 120, is guided through the anode feed line 132, the anode line 134, and the anode discharge line 136 directly into the exhaust system 150. If it is then detected during the flushing procedure of the anode line system 130 that the hydrogen signal essentially increases (for example, at the time t2 in FIG. 2), the flushing procedure can be defined as terminated and ended again, i.e. the flushing valve 137 is closed and the recirculation pump 139 is activated again, so that the fuel-cell system 100 changes back into the normal operating mode.

An exemplary method incorporating teachings of the present disclosure for detecting and locating the leak in the fuel-cell system 100 of FIG. 1 is described hereinafter with additional reference to the flow chart shown in FIG. 3.

The method of FIG. 3 starts at step 300 and then proceeds to step 310, at which a hydrogen signal is received from the hydrogen sensor 151 by the control device 160, in particular the first control device section 162. At this point, it is to be noted once again that the control device 160, in particular the first control device section 162, continuously receives the hydrogen signal of the hydrogen sensor 151. Therefore, (digital) hydrogen signals of the hydrogen sensor 151 are received permanently and continuously, for example, at predetermined time intervals, such as a few milliseconds, during the performance of the method according to the invention.

In a following step 320, it is determined whether the received hydrogen signal indicates a hydrogen concentration that exceeds the predetermined hydrogen concentration threshold value C_H2. In particular, if the predetermined hydrogen concentration threshold value C_H2 is exceeded, there is an increased risk of ignition of the gas mixture present in the exhaust system 150. If it is determined in step 320 that the received hydrogen signal indicates a hydrogen concentration which does not exceed the predetermined hydrogen concentration threshold value C_H2, the method reverts to step 310. The fuel-cell system 100 can be diagnosed as leak-tight as long as the method remains at steps 310, 320.

However, if it is determined in step 320 that the received hydrogen signal indicates a hydrogen concentration value which exceeds the predetermined hydrogen concentration threshold value C_H2, the method proceeds to step 330, at which the control device 160, in particular the second control device section 164, transmits a diagnosis signal which prompts the fuel-cell system 100 to change into a diagnostic operating mode. Transmitting the diagnosis signal can comprise transmitting a cathode inlet valve closing signal, which causes closing of the cathode inlet valve 145. Additionally or alternatively, transmitting the diagnosis signal comprises transmitting a cathode outlet valve closing signal, which causes closing of the cathode outlet valve 147. In some embodiments, transmitting the diagnosis signal can comprise transmitting a throttle valve closing signal, which causes closing of the throttle valve 174.

In general, transmitting the diagnosis signal has the effect that no gas mixture which flowed through the cathode line 144 and therefore interacted with the cathode reaches the exhaust line and also no gas mixture having hydrogen can flow out of the anode line system to the cathodes. If, for example, the cathode inlet valve 145 and/or the cathode outlet valve 147 is closed, the gas mixture, in particular air, conveyed by the compressor 170 can flow directly into the exhaust system 150, without coming into contact with the cathode of the fuel cell 110. Closing the throttle valve 174 has the effect that the gas mixture flowing through the exhaust system 150 can no longer originate from the cathode line system 140. Rather, the gas mixture then flowing through the exhaust system 150 originates from the anode line system 130.

In a following step 340, after a predetermined duration, such as approximately 5 seconds (see period of time between t2 and t3 in FIG. 2), after the detected time t2 of the end of the flushing procedure of the anode line system 130, a hydrogen signal is received from the hydrogen sensor 151 and evaluated in a following step 350. That is to say that the time t2 also indicates an end of a hydrogen emission.

If it is detected in step 350 that the hydrogen signal received at time t3 has an essentially decreasing course, the method proceeds to step 360, at which the membrane is diagnosed as leaky. In particular, it can be precluded due to the diagnostic operation of the fuel-cell system 100 that the hydrogen present in the exhaust system 150 and detected by the hydrogen sensor 151 originates from the cathode line system 140. Therefore, in the case of an essentially decreasing hydrogen signal at the time t3, it can be presumed that the hydrogen previously present in the exhaust system 150 originates from the cathode line system 140, in particular due to a leaky membrane of the fuel cell 110. Due to the diagnostic operation of the fuel-cell system, for example, by closing the cathode inlet valve 145 and/or the cathode outlet valve 147, the hydrogen flowing through the leaky membrane can no longer flow into the exhaust system 150, because of which the hydrogen signal is essentially decreasing.

However, if it is detected in step 350 that the hydrogen signal received at the time t3 has an essentially non-decreasing course, the method proceeds to step 370, at which the flushing valve 137 is diagnosed as leaky. In particular, it can be precluded due to the diagnostic operation of the fuel-cell system 100 that the hydrogen present in the exhaust system 150 and detected by the hydrogen sensor 151 originates from the cathode line system 140. Therefore, in the case of an essentially non-decreasing hydrogen signal at the time t3, it can be presumed that the hydrogen previously present in the exhaust system 150 originates from the anode line system 130, in particular due to a leaky flushing valve 137. Due to the diagnostic operation of the fuel-cell system, for example, by closing the cathode inlet valve 145 and/or the cathode outlet valve 147, the hydrogen flowing through the flushing valve 137 can still flow into the exhaust system 150, because of which the hydrogen signal is not decreasing. For example, the hydrogen signal can be essentially constant.

The detection in step 360 or 370 is carried out by the control device 160, in particular the third control device section 166.

After steps 360, 370, the method proceeds in each case to step 380, at which the control device 160, in particular the fourth control device section 168, can transmit a control signal which indicates that the membrane or the flushing valve 137 is at least partially leaky, before the method ends at step 390.

To accelerate the diagnosis just described, after the closing of the cathode inlet valve 145 and/or the cathode outlet valve 147, the method may include at least partially opening the cathode bypass valve 149. In some embodiments, transmitting the diagnosis signal can also comprise transmitting a bypass valve opening signal, which causes at least partial opening of the cathode bypass valve 149. In this way, the gas mixture previously present in the exhaust system 150 can be flushed out of the exhaust system 150 faster by fresh gas mixture conveyed by the compressor 170.

Detecting that the membrane of the fuel cell 110 of the fuel-cell system 100 is at least partially leaky (see step 350) can in this case comprise detecting that the hydrogen signal received during the diagnostic operation of the fuel-cell system indicates a hydrogen concentration value of essentially zero.

However, if it is detected that the hydrogen signal received during the diagnostic operation of the fuel-cell system 100 indicates a hydrogen concentration value which is greater than zero, the flushing valve 137 can in turn be diagnosed as at least partially leaky. Due to the leaky flushing valve 137, in this case the gas mixture in the exhaust line consists of a gas mixture comprising hydrogen from the anode line system 130 and of fresh gas mixture from the cathode line system 140.

The hydrogen signal of a hydrogen sensor 151 arranged in the exhaust system of a fuel-cell system can be used, if a general leak is detected in the fuel-cell system 100, to additionally also locate the leak, in particular to associate it with the membrane or the flushing valve 137. This can take place in a simple manner by blocking the gas mixture flowing through the cathode of the fuel cell 110 by evaluating the hydrogen signal of the hydrogen sensor 151 arranged in the exhaust system 150.

What is claimed is:

1. A method for detecting a leak in a fuel-cell system with an exhaust system, the method comprising:
receiving a hydrogen signal from a hydrogen sensor arranged in the exhaust system, wherein the hydrogen signal represents a hydrogen concentration in a gas mixture present in the exhaust system;
transmitting a diagnosis signal prompting the fuel-cell system to change into a diagnostic operating mode, if the received hydrogen signal indicates a hydrogen concentration value in the exhaust system exceeding a predetermined hydrogen concentration threshold value;
determining a membrane of a fuel cell of the fuel-cell system is at least partially leaky if the hydrogen signal received during the diagnostic operation of the fuel-cell system is essentially decreasing, or a flushing valve arranged in the anode line system e is at least partially leaky if the hydrogen signal received during the diagnostic operation of the fuel-cell system is not essentially decreasing; and
transmitting a control signal indicating which of the membrane or the flushing valve is at least partially leaky.

2. The method as claimed in claim 1, wherein transmitting the diagnosis signal comprises:
transmitting a cathode inlet valve closing signal causing closing of a cathode inlet valve arranged in a cathode feed line of a cathode line system, wherein the cathode feed line supplies a gas mixture comprising oxygen to a cathode of the fuel-cell system; and/or
transmitting a cathode outlet valve closing signal causing closing of a cathode outlet valve arranged in a cathode discharge line of the cathode line system discharging the gas mixture comprising oxygen supplied to the cathode of the fuel-cell system into the exhaust system.

3. The method as claimed in claim 2, wherein transmitting the diagnosis signal comprises
transmitting a bypass valve opening signal causing at least partial opening of a cathode bypass valve arranged in a cathode bypass line connecting the cathode feed line to the cathode discharge line;
wherein determining the membrane of the fuel cell of the fuel-cell system is at least partially leaky comprises detecting that the hydrogen signal received during the diagnostic operation of the fuel-cell system indicates a hydrogen concentration value of essentially zero; and/or
determining the flushing valve of the fuel-cell system is at least partially leaky comprises detecting that the hydrogen signal received during the diagnostic operation of the fuel-cell system indicates a hydrogen concentration value which is greater than zero.

4. The method as claimed in claim 1, wherein transmitting the diagnosis signal comprises
transmitting a throttle valve closing signal causing closing of a throttle valve arranged in the cathode discharge line downstream from the cathode outlet valve.

5. The method as claimed in claim 1, wherein:
the control signal actuates an operator interface to display a warning to an operator of the fuel-cell system;
the warning informs the operator that a leak of the membrane or the flushing valve has been detected.

6. (canceled)

7. A control device comprising:
a first control device section for receiving a hydrogen signal from a hydrogen sensor;
a second control device section for transmitting a diagnosis signal;
a third control device section for determining that a membrane or a flushing valve is at least partially leaky; and
a fourth control device section for transmitting a control signal;
the control device operable to detect a leak in a fuel-cell system with an exhaust system by:
receiving a hydrogen signal from a hydrogen sensor arranged in the exhaust system, wherein the hydrogen signal represents a hydrogen concentration in a gas mixture present in the exhaust system;
transmitting a diagnosis signal prompting the fuel-cell system to change into a diagnostic operating mode, if the received hydrogen signal indicates a hydrogen concentration value in the exhaust system exceeding a predetermined hydrogen concentration threshold value;
determining a member of a fuel cell of the fuel-cell system is at least partially leaky if the hydrogel signal received during the diagnostic operation of the fuel-cell system is essentially decreasing, or a flushing valve arranged in the anode line system is at least partially leaky if the hydrogen signal received during the diagnostic operation of the fuel-cell system is not essentially decreasing; and
transmitting a control signal indicating which of the membrane or the flushing valve is at least partially leaky.

8. A leaktightness-analyzing device for a fuel-cell system, comprising:
a hydrogen sensor to generate a hydrogen signal that is representative of a hydrogen concentration in a gas mixture present in an exhaust system of the fuel-cell system; and
a control device as recited in claim 7.

9-12. (canceled)
